(19) United States
(12) Patent Application Publication
(10) Pub. No.: US 2014/0292801 A1
(43) Pub. Date: Oct. 2, 2014

(54) COLOR SIGNAL PROCESSING METHOD AND APPARATUS, AND STORAGE MEDIUM FOR PERFORMING THE METHOD

(71) Applicant: SAMSUNG ELECTRONICS CO., LTD., Suwon-si (KR)

(72) Inventors: Youn-jin KIM, Pocheon-si (KR); Seung-ran PARK, Hwaseong-si (KR); Seong-wook HAN, Suwon-si (KR)

(73) Assignee: SAMSUNG ELECTRONICS CO., LTD., Suwon-si (KR)

(21) Appl. No.: 14/226,332

(22) Filed: Mar. 26, 2014

(30) Foreign Application Priority Data
Mar. 26, 2013 (KR) 10-2013-0032367

(51) Int. Cl. G09G 5/02

(52) U.S. Cl. CPC G09G 5/02
USPC 345/604

(57) ABSTRACT

Methods, apparatuses and storage mediums for processing color signals of an image are provided. A method includes converting an input signal in a first color space into a luminance component and a saturation component in a second color space, determining a boundary of the second color space by using the luminance component and the saturation component, determining whether the converted input signal is outside the boundary, and matching the saturation component so that the converted input signal outside the boundary of the second color space enters the second color space. The method may be carried out by a non-transitory computer readable storage medium. An apparatus includes a color signal a color space converter configured to convert an input signal in a first color space into a luminance component and a saturation component in a second color space; a color space boundary determiner configured to determine a boundary of the second color space by using the luminance component and the saturation component, and determine whether the converted input signal is outside the boundary; and a saturation matcher configured to match the saturation component so that the converted input signal outside the boundary of the second color space enters into the boundary of the second color space.

### CROSS REFERENCE TO RELATED APPLICATIONS

This application claims priority from Korean Patent Application No. 10-2013-0032367, filed on Mar. 26, 2013, in the Korean Intellectual Property Office, the disclosure of which is incorporated herein by reference, in its entirety.

### BACKGROUND

1. Technical Field

Methods, apparatuses and storage media consistent with the exemplary embodiments relate to color signal processing technology. More particularly, the exemplary embodiments relate to a method to prevent image deterioration caused by conversion of a color space, by preventing distortion of brightness and a color signal due a difference between used color spaces.

2. Description of the Related Art

Generally, color input/output apparatuses such as monitors, scanners, cameras, printers, etc. use different color spaces or color models depending on an application field in order to reproduce a color. For example, in order to display a color image, color cathode ray tube (CRT) monitors or computer graphics apparatuses use an RGB color space color image, while apparatuses that control a color, saturation, and brightness use an HSI color space.

Although the same color is intended to be displayed, a color difference occurs between different kinds of apparatuses due to a difference between different color spaces. For this reason, color adjustment is needed for correcting a color difference occurring between different kinds of apparatuses.

Moreover, even in the case of the same apparatuses, in response to the standard being changed or the apparatuses are manufactured by different manufacturers, color adjustment for matching a color is needed for expressing the same color.

In the related art, when conversion of a color space or conversion of a data range is needed in processing a color image, a clipping method or a device-independent color space-based processing method are mainly used.

In the clipping method, the number of calculations is small, but an error between a before-conversion signal and an after-conversion signal is large. The device-independent color space-based processing method has a complicated calculation process. For this reason, it is difficult to apply these methods to an apparatus for processing color signals in real-time.

### SUMMARY

One or more exemplary embodiments include a method and apparatus that perform an adaptive saturation mapping scheme to maintain a brightness component and a hue component of an input signal by analyzing the brightness component and hue component of the input signal, thereby preventing a signal from being distorted by conversion of a color space.

Additional aspects will be set forth in part in the description which follows and, in part, will be apparent from the description, or may be learned by practice of the exemplary embodiments.

According to one or more exemplary embodiments, a color signal processing method includes: converting an input signal in a first color space into a luminance component and a saturation component in a second color space: determining a boundary of the second color space by using the luminance component and the saturation component; determining whether the converted input signal is outside the boundary; and matching the saturation component such that the converted input signal outside the boundary of the second color space enters into the boundary of the second color space.

The matching of the saturation component may include adjusting the saturation component without any change in the luminance component of the converted input signal.

The determining of the boundary may include predicting cusp coordinates on the basis of a hue component of the input signal.

The determining of the boundary may include extracting a boundary point having the same luminance component as the converted input signal and the same hue component as the converted input signal.

The determining of the boundary may include: storing anchor color coordinates; and extracting a boundary point having the same luminance component as the converted input signal and the same hue component as the converted input signal by using the anchor color coordinates.

The anchor color coordinates may include cusp coordinates of R, G, B, C, M, and Y.

The matching of the saturation component may include matching the saturation component of the converted input signal with a saturation component of the boundary point.

The matching of the saturation component may include matching the saturation component of the converted input signal with a saturation component of the boundary point that is extracted by using the anchor color coordinates.

The color signal processing method may further include inversely converting the converted input signal into the first color space.

The second color space may be a device-dependent color space.

The device-dependent color space may be one of RGB, YCbCr, HSI, HSV, and HSL color spaces.

The color signal processing method may further include performing a color space conversion on the RGB image to separate the input signal into the luminance component and the saturation component in response to the input signal being an RGB image p.

According to one or more exemplary embodiments, a color signal processing apparatus includes: a color space converter configured to convert an input signal in a first color space into a luminance component and a saturation component in a second color space; a color space boundary determiner configured to determine a boundary of the second color space by using the luminance component and the saturation component, and also determines whether the converted input signal is outside the boundary; and a saturation matcher configured to match the saturation component such that the converted input signal outside the boundary of the second color space enters into the boundary of the second color space.

The saturation matcher may be configured to adjust the saturation component without any change in a luminance component of the converted input signal.

The color space boundary determiner may be configured to predict cusp coordinates on a basis of a hue component of the input signal.

The color space boundary determiner may be configured to extract a boundary point having the same luminance component as the converted input signal and the same hue component as the converted input signal.

The color space boundary determiner may include: a memory configured to store anchor color coordinates; and a boundary point extractor configured to extract a boundary point having the same luminance component as the converted input signal and the same hue component as the converted input signal, by using the anchor color coordinates.

The anchor color coordinates may include a cusp coordinate of R, G, B, C, M, and Y.

The saturation matcher may be configured to match the saturation component of the converted input signal with a saturation component of the boundary point.

The saturation matcher may be configured to match the saturation component of the converted input signal with a saturation component of the boundary point that is extracted by using the anchor color coordinates.

The color signal processing apparatus may further include an inverse converter configured to inversely convert the converted input signal into the first color space.

The second color space may be a device-dependent color space.

The device-dependent color space may be one of RGB, YCbCr, HSI, HSV, and HSL color spaces.

In response to the input signal being an RGB image, the color signal processing apparatus may perform a color space conversion on the RGB image in order to separate the input signal into the luminance component and the saturation component.

An aspect of an exemplary embodiment may provide a color signal processing apparatus including: a color space converter configured to convert an input signal in a first color space into a luminance component and a saturation component in a second color space; a color space boundary determiner configured to determine a boundary of the second color space by using the luminance component and the saturation component, and determine whether the converted input signal is outside the boundary; and a saturation matcher configured to match the saturation component while maintaining the luminance component and a hue component without change that the saturation component of the converted input signal outside the boundary of the second color space enters into the boundary of the second color space.

The color space boundary determiner may be configured to predict cusp coordinates on a basis of the hue component of the input signal.

The color space boundary determiner may include a memory configured to store anchor color coordinates.

The anchor color coordinates may include cusp coordinates of R, G, B, C, M and Y.

The color signal processing apparatus may further include an inverse converter configured to inversely convert the converted input signal into the first color space.

### BRIEF DESCRIPTION OF THE DRAWINGS

These and/or other aspects will become apparent and more readily appreciated from the following description of the exemplary embodiments, taken in conjunction with the accompanying drawings of which:

FIG. 1 is a diagram which illustrates an example wherein a color is adjusted with any consideration of a relationship between color components in a YCbCr color space;

FIG. 2 is a block diagram which illustrates an apparatus for processing color signals of an image according to an exemplary embodiment;

FIG. 3 is a diagram which illustrates the YCbCr color space;

FIG. 4 is a diagram which illustrates a YCbCr cross-sectional surface and cusp of a specific color according to an exemplary embodiment;

FIG. 5A is a diagram which illustrates an HSL color space;

FIG. 5B is a diagram which illustrates an HSV color space;

FIG. 6 is a diagram showing a lookup table of R, G, B, C, M, and Y of the HSL color space;

FIG. 7 is a flowchart which illustrates a method of processing color signals of an image according to an exemplary embodiment;

FIG. 8 is a block diagram which illustrates a detailed configuration of a color space boundary determiner according to an exemplary embodiment;

FIG. 9 is a diagram which illustrates a saturation matching method according to an exemplary embodiment;

FIG. 10 is a block diagram which illustrates a detailed configuration of an apparatus for processing color signals of an image according to an exemplary embodiment; and

FIG. 11 is a flowchart which illustrates a detailed operation of a method of processing color signals of an image according to an exemplary embodiment.

### DETAILED DESCRIPTION OF THE EXEMPLARY EMBODIMENTS

Reference will now be made in detail to the exemplary embodiments, examples of which are illustrated in the accompanying drawings, wherein like reference numerals refer to the like elements throughout. In this regard, the exemplary embodiments may have different forms and should not be construed as being limited to the descriptions set forth herein. Accordingly, the exemplary embodiments are merely described below, by referring to the figures, to explain aspects of the present description.

The exemplary embodiments are not meant to restrict or limit the scope of the disclosure. Technical experts in the field from the detailed description and examples of the exemplary embodiments may be easily inferred and may be interpreted as falling within the scope of the claims.

The human vision system is sensitive to luminance. In an RGB color space, three colors such as red (R), green (G), and blue (B) have the same weight, and thus, all color components are generally stored at the same resolution. However, since the human vision system is more sensitive to luminance than to saturation, a luminance component is separated from a color component, and by expressing the luminance component at a relatively higher resolution, a color image is effectively expressed.

An example of a color space, which is expressed by separating a luminance component from a color component, is a YCbCr color space. In the YCbCr color space, Y denotes a luminance component of a color, and each of Cb and Cr denotes a saturation component. In the YCbCr color space, the luminance component and saturation component of a color are separated from each other, but a distribution of saturation components is not constant for each luminance, and a distribution of saturation components is also not constant for each hue.

Therefore, in adjusting each component of a color in the YCbCr color space, in response to a color being adjusted by uniformly applying an adjustment function, the adjusted color exceeds a range of a color space for expressing the color.

In other words, in the YCbCr color space, a plurality of color components are not separated from each other and have a relationship with a different color component. Therefore, when desiring to adjust a color, a color is adjusted in consideration of a relationship with the other color components.

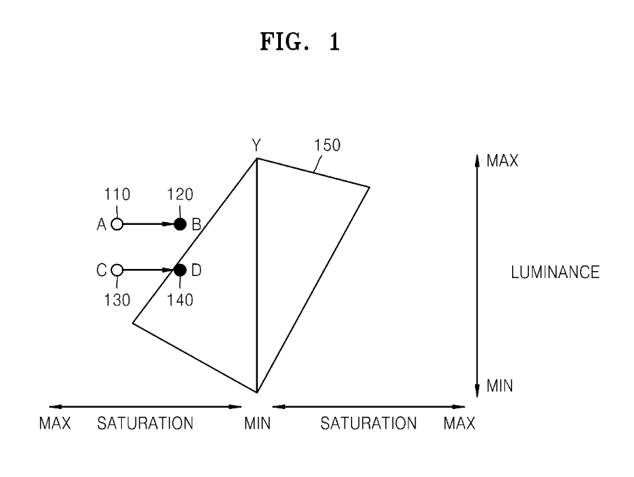

FIG. 1 is a diagram which illustrates an example wherein a color is adjusted with no consideration of a relationship between color components in the YCbCr color space.

In response to saturations of a color A 110 and a color C 130 illustrated as dots are reduced to the same amount with no consideration of luminance, the color A 110 moves to a color B 120, and the color C 130 moves to a color D 140. The color D 140 of low luminance, which is a result obtained by reducing luminance of the color C 130, is in a color gamut, and thus, may be expressed by a display device.

However, the color B 120 obtained by correcting the color A 110 of higher luminance is out of the color gamut, and thus, is not expressed by the display device. That is, in the YCbCr color space, a luminance component and a saturation component, which are color components, affect a different component and are affected by the different component. Therefore, when desiring to adjust a color component, the color component may be adjusted in consideration of a relationship with the other color components.

In an exemplary embodiment, in response to converting a color space of a color signal in consideration of a relationship between components comprising a color, a color is adjusted so that a converted color does not deviate from a color space after the conversion.

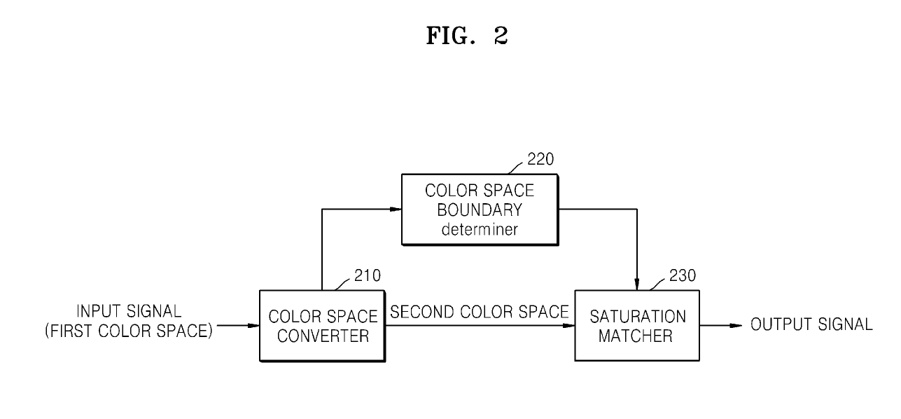

FIG. 2 is a block diagram which illustrates an apparatus for processing color signals of an image according to an exemplary embodiment.

Referring to FIG. 2, the apparatus for processing color signals of an image according to an exemplary embodiment may include a color space converter 210, a color space boundary determiner 220, and a saturation matcher 230.

The color space converter 210 converts an input signal in a first color space into a luminance component and a saturation component in a second color space. A color space conversion denotes that a color signal encoded into a color system is converted into a signal in another color system.

According to an exemplary embodiment, in response to an input signal corresponds to an RGB image, by performing a color space conversion on the RGB image, the input signal into separated into a luminance component and a saturation component.

According to an exemplary embodiment, the second color space is a device-dependent color space. The device-dependent color space is used in a current device and is a color space which is not compatible with coordinates of a color space of a different device.

Since the device-dependent color space is not compatible with the coordinates of a color space of a different device, a color is distorted. Examples of color distortion include color distortion between different kinds of devices, color distortion between the same kind of devices, and color distortion between the same kind of devices made by the same manufacturer.

An example of color distortion between different kinds of devices may include a case in which a color is distorted because a color, luminance, saturation, etc. of the original image are changed, when a color image and file of a camera or a scanner is transferred to and displayed by a monitor.

An example of, color distortion between the same kind of devices may include a case in which a color image file of a monitor manufactured by A company is moved or transferred to and displayed by a monitor manufactured by B company, resulting in a color being distorted.

An example of color distortion between the same kind of devices of the same maker may include a case in which a color image file of a 17-inch monitor manufactured by A company is moved or transferred to and displayed on a 19-inch monitor manufactured by the A company, a color is distorted.

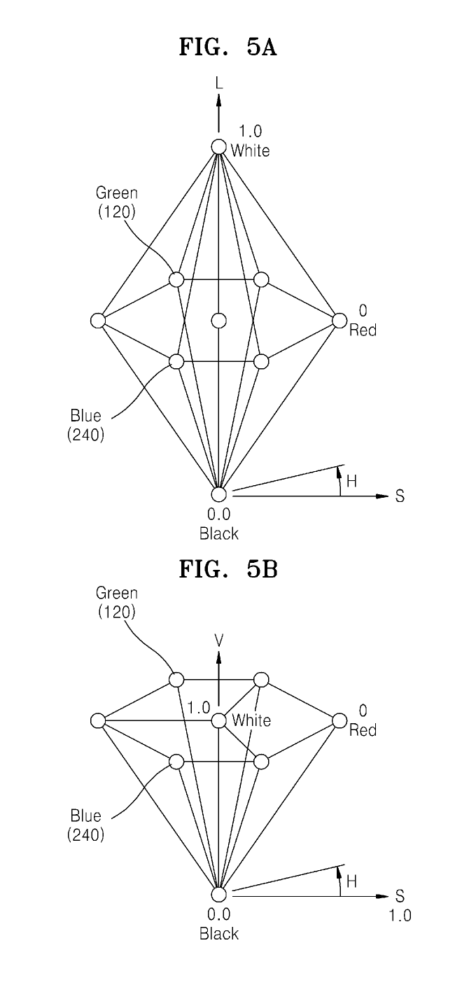

A device-dependent color space according to an exemplary embodiment may be YCbCr, HSI, HSV, or HSL. A detailed characteristic based on kind of the device-dependent color space will be described below with reference to FIGS. 5A and 5B.

In an exemplary embodiment, an image signal is assumed to be converted from the RGB color space (a first color space) into the YCbCr color space (a second color space).

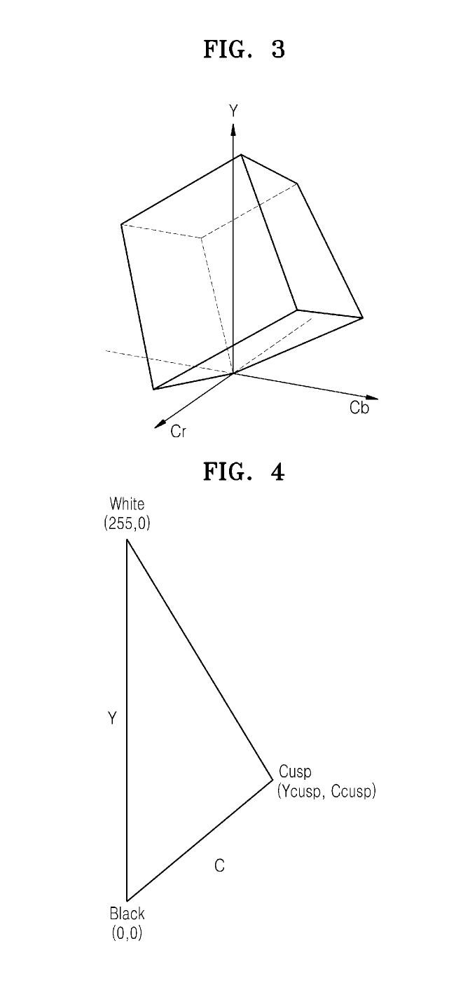

The YCbCr color space obtained by the color space converter 210 is expressed as shown in FIG. 3. A conversion from the RGB color space into the YCbCr color space may be expressed by Equation (1).

Y=kr*R+kg*G+kb*B

Cb=B−Y

Cr=R−Y

Cg=G−Y (1)

Referring to FIG. 3, in a corrected YCbCr color space, a height denotes a luminance (Y), a distance from a central axis denotes a saturation (S), and an angle rotated from one reference axis (a Cr axis in the embodiment) denotes a color (H). Color components (Y, S, H) of a certain pixel may be expressed as the following Equation (2) when being expressed as values in the corrected YCbCr color space.

$$S = \sqrt{{Cb}^{2} + {Cr}^{2}} \\ H = arctan ( \frac{Cb}{Cr} ) \qquad ( 2 )$$

The color space boundary determiner 220 predicts a cusp based on a color of a converted input signal in the second color space by using a luminance component and a saturation component of the input signal obtained by the color space converter 210, and determines a boundary of the second color space. Also, the color space boundary determiner 220 determines whether the converted input signal is inside the boundary of the second color space.

Specifically, the color space boundary determiner 220 predicts cusp coordinates based on a color of an input signal. The cusp is the maximum saturation point of a hue plane containing a certain color signal, and is expressed via two coordinates such as luminance (Y) and saturation (C) in a color space.

FIG. 4 is a diagram which illustrates a YCbCr cross-sectional surface and cusp of a specific color according to an exemplary embodiment. Referring to FIG. 4, a cusp is predicted as the maximum saturation point (Ycusp, Ccusp) in a YCbCr cross-sectional surface of a color specified based on an input signal.

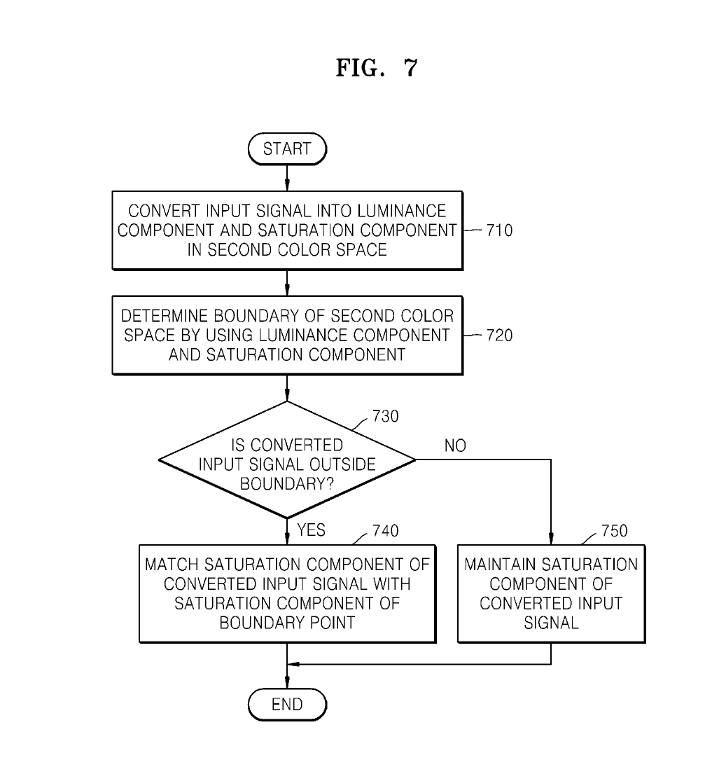

A detailed method of predicting a cusp will be described below with reference to FIG. 7.

A boundary in the second color space according to an exemplary embodiment is determined by extracting a boundary point having the same luminance component and hue component as those of a converted input signal.

Anchor color coordinates may be used for extracting the boundary point having the same luminance component and hue component as those of the converted input signal. The anchor color coordinates according to an exemplary embodiment include cusp coordinate values of red (R), green (G), blue (B), cyan (C), magenta (M), and yellow (Y).

In response to a boundary point in the second color space being determined, the color space boundary determiner 220 determines whether the coordinate values of the converted input signal are outside or inside a boundary with respect to the boundary point.

The saturation matcher 230 receives the determined result of a position of the converted input signal from the color space boundary determiner 220. The determination result regarding the position of the converted input signal is information that is obtained by determining whether the coordinates of the converted input signal are outside or inside the boundary with respect to the extracted boundary point.

In response to the converted input signal being outside the boundary of the second color space as the determined result, the saturation matcher 230 matches saturation components in order for the converted input signal to enter into the boundary of the second color space.

A saturation component matching operation according to an exemplary embodiment is performed by the saturation matcher 230. The saturation matcher 230 matches a saturation component of the converted input signal with a saturation component of the boundary point having the same luminance component and hue component as those of the converted input signal.

The saturation matcher 230 matches the saturation component of the converted input signal, which is outside the boundary of the second color space, with the saturation component of the boundary point, thereby enabling an input signal to be expressed in the second color space.

That is, a problem such as signal distortion caused by a difference between the first and second color spaces is solved by adjusting the converted input signal which does not deviate from the boundary point of the second color space.

Moreover, among the color components, the luminance component and the hue component are maintained without any change separately from the saturation component, and by adjusting the saturation component, the same color as that in the first color space is expressed.

In response to the converted input signal being inside the boundary of the second color space as the determined result, the saturation matcher 230 maintains the saturation component of the converted input signal.

According to an exemplary embodiment, by performing an adaptive saturation mapping scheme to maintain a brightness component and hue component of an input signal by analyzing the brightness component and hue component of the input signal, the number of data calculations is reduced compared to a device-independent color space-based method, and the problem of a deterioration of a color signal is solved.

In FIGS. 3 and 4, a case in which the second color space is the YCbCr color space is illustrated, has been described above. The second color space according to an exemplary embodiment is the device-dependent color space, and the second color space may be of an RGB, HSI, HSV, or HSL type in addition to the YCbCr color space.

The RGB color space denotes a color model that defines a color with red, green, and blue, or denotes a color that is obtained by mixing red, green, and blue (which are three primary colors of light) in a color expression scheme. Such an RGB scheme is used for other display devices using light, instead of color television, color monitors of computers, or printing mediums.

All colors in the RGB color space are generated by combining the three primary colors, but this is insufficient to express a color in terms of how the human eyes perceive a color. Therefore, the HSI, HSV, and HSL color spaces have been newly developed based on how the human's eyes and brains recognize a color.

The HSI color space is a model based on a color recognition method, and is composed of hue, saturation, and intensity. In the HSI color space, hue (H) denotes a primary color of a color, saturation (S) denotes a purity of a color and denotes by which degree white is mixed with a primary color, and intensity (I) enables a human to feel brightness and darkness of a color with intensity of light.

The HSL color space is a color space for expressing a color by hue, saturation, and intensity. FIG. 5A is a diagram which illustrates the HSL color space. Referring to FIG. 5, L denotes a degree of brightness. White is the brightest color is set to 1.0, black is set to 0, and all of the other colors have brightness between white and black.

In the HSV color space, V denotes a degree of brightness. FIG. 5B is a diagram illustrating the HSV color space. Referring to FIG. 5B, the brightest white, red, green, and blue are all set to the same brightness, namely, 1.0, in the HSV color space unlike the HSL color space.

The HSL color space or the HSV color space has a difference with respect to a characteristic according to which a human actually recognizes a color, but is a conceptual color space which is suitable to use in response to finding or relatively expressing an arbitrary color.

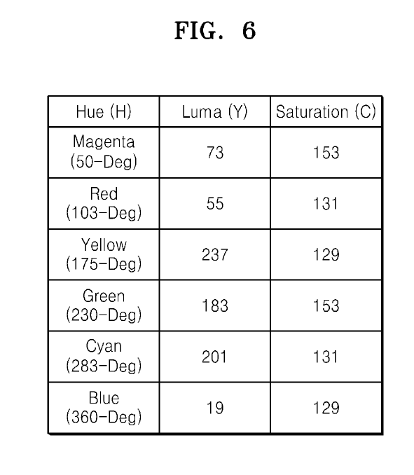

FIG. 6 is a diagram showing a lookup table of R, G, B, C, M, and Y of the HSL color space. With respect to coordinate values listed in FIG. 6, cusp coordinates of an input signal may be found, and a boundary point may be calculated.

FIG. 7 is a flowchart which illustrates a method of processing color signals of an image according to an exemplary embodiment.

In operation 710, the method converts an input signal in the first color space into a luminance component and a saturation component in the second color space.

In operation 720, the method determines a boundary in the second color space by using the luminance component and saturation component of the converted input signal.

In operation 730, the method calculates coordinate values of the converted input signal, and determines whether a position of the input signal is outside or inside the determined boundary by using the luminance component and saturation component of the converted input signal.

In operation 740, in response to coordinates of the converted input signal being outside the boundary which is determined in operation 720, the method matches the saturation component of the converted input signal with a saturation component of a boundary point. Here, the boundary point has the same luminance component and hue component as those of the converted input signal.

Operation 750 relates to a case in which the coordinates of the converted input signal are inside the boundary which is determined in operation 720. In response to the coordinates of the converted input signal being inside the boundary, a color in the second color space is expressed identically to that in the first color space, and thus, the method maintains the saturation component of the converted input signal.

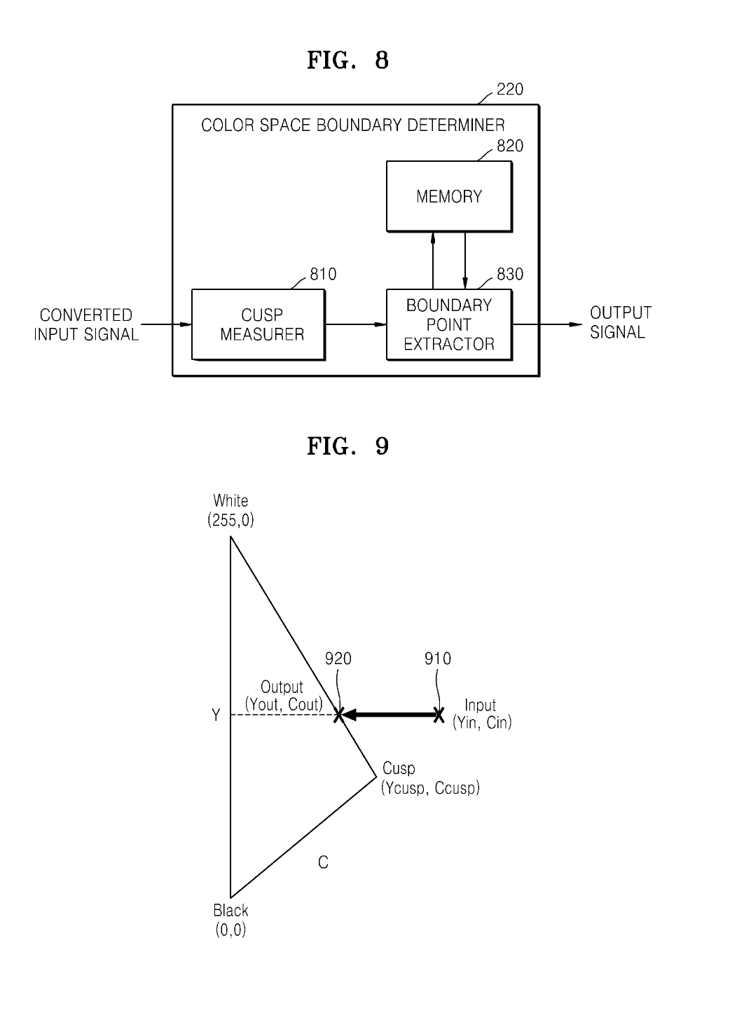

FIG. 8 is a block diagram which illustrates a detailed configuration of the color space boundary determiner 220 according to an exemplary embodiment.

Referring to FIG. 8, the color space boundary determiner 220 includes a cusp measurer 810, a memory 820, and a boundary point extractor 830.

The cusp measurer 810 predicts coordinates of the maximum saturation point on a hue plane including a converted input signal. The cusp measurer 810 may predict a cusp based on a color of the converted input signal with reference to cusp coordinate values of six samples, such as R, G, B, C, M, and Y, stored in the memory 820.

The cusp coordinate values of six samples, such as R, G, B, C, M, and Y, stored in the memory 820, are changed depending on a kind of second color space, and as seen in FIGS. 5A and 5B, a shape of a color space is changed depending on a kind of color space.

The boundary point extractor 830 extracts a boundary point having the same hue and luminance as those of the converted input signal with reference to the coordinate values stored in the memory 820. The color space boundary determiner 220 may determine whether the converted input signal is inside the boundary, on the basis of the boundary point extracted by the boundary point extractor 830.

An output signal, which is output through a series of operations performed by the color space boundary determiner 220, includes information on positions with respect to a color space boundary of the converted input signal.

The output signal is used to adjust a saturation component of the converted input signal transferred to the saturation matcher 230.

FIG. 9 is a diagram which illustrates a saturation matching method according to an exemplary embodiment. Referring to FIG. 9, coordinates (Input) 910 of an input signal converted into the second color space are illustrated. The input signal is converted into a luminance component and a saturation component in the second color space. According to the converted result, in FIG. 9, the input signal converted into the second color space is outside a boundary of the second color space.

Therefore, the saturation component of the converted input signal outside the boundary of the second color space may be adjusted to a saturation component of a boundary point 920 of the second color space. At this time, a luminance component and a hue component are maintained without any change, and a saturation component of the converted input signal (Input) 910 is matched with that of the boundary point 920.

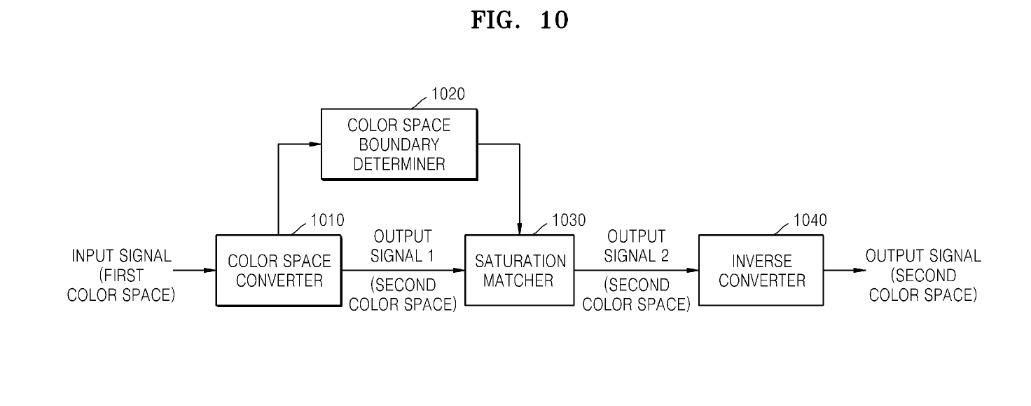

FIG. 10 is a block diagram which illustrates a detailed configuration of an apparatus for processing color signals of an image according to an exemplary embodiment. Referring to FIG. 10, the apparatus for processing color signals of an image according to an exemplary embodiment includes a color space converter 1010, a color space boundary determiner 1020, a saturation matcher 1030, and an inverse converter 1040.

The color space converter 1010, the color space boundary determiner 1020, and the saturation matcher 1030 have the same functions as the color space converter 210, color space boundary determiner 220, and saturation matcher 230 of FIG. 2, respectively.

In particular, the color space converter 1010 converts an input signal into a luminance component and a saturation component in the second color space, and the color space boundary determiner 1020 determines whether the converted input signal is outside a color space boundary.

In response to the converted input signal being outside the color space boundary as the determined result, the saturation matcher 230 matches a saturation component of the with a saturation component of a boundary point.

In response to the converted input signal being inside the color space boundary as the determined result, a value of the converted saturation component is maintained.

According to an exemplary embodiment, the inverse converter 1040 inversely performs the conversion operation of the color space converter 1010 to again convert the converted input signal into a type suitable for the first color space.

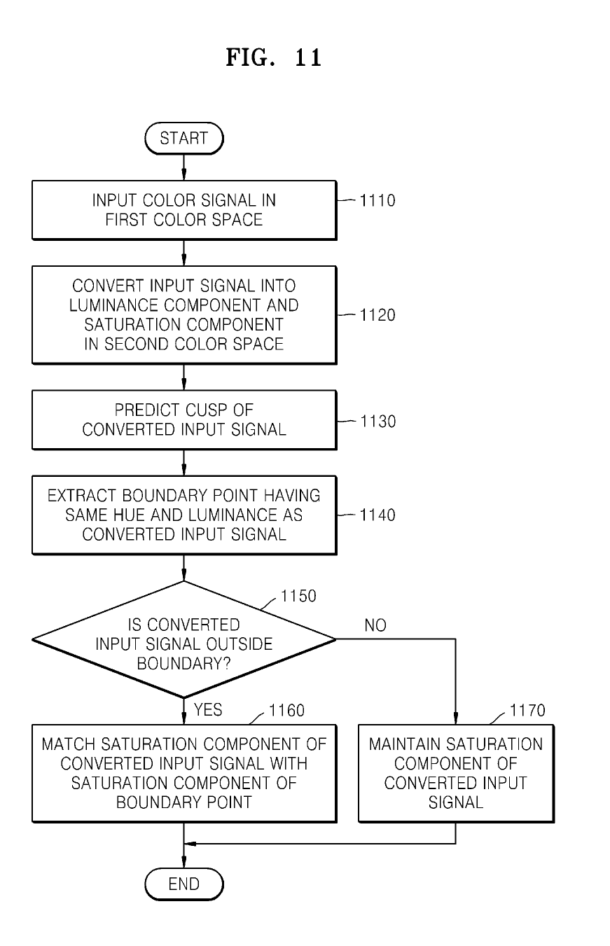

FIG. 11 is a flowchart which illustrates a detailed operation of a method of processing color signals of an image according to an exemplary embodiment.

In operation 1110, a color signal in the first color space is input.

In operation 1120, the input signal in the first color space is converted into a saturation component and a luminance component in the second color space.

In operation 1130, the method predicts a cusp based on a color of the converted input signal which is obtained in operation 1120. At this time, according to an exemplary embodiment, the method may predict the cusp based on the color of the input signal with reference to cusp values of anchor color coordinates stored in the memory 820.

In operation 1140, the method extracts a boundary point having the same hue and luminance as the converted input signal.

In operation 1150, the method determines whether the converted input signal is outside or inside a boundary with respect to a boundary point of the second color space.

Operation 1160 relates to a case in which the converted input signal is outside the boundary of the second color space, and the saturation component of the converted input signal is matched with a saturation component of the boundary point of operation 1150.

Operation 1170 relates to a case in which the converted input signal is inside the boundary of the second color space, and the saturation component of the converted input signal is maintained.

The exemplary embodiments may be implemented in the form of a non-transitory computer readable storage medium that includes computer executable instructions, such as program modules. Computer-readable media may be any available media that may be accessed by the computer and includes both volatile and nonvolatile media, removable and non-removable media. In addition, the computer-readable media may include computer storage media and communication media. Computer storage media includes both volatile and non-volatile media and removable and non-removable media implemented by any method or technology for storage of information such as computer readable instructions, data structures, program modules or other data. The medium of communication is typically in the form of computer-readable instructions or other data in a modulated data signal such as data structures, program modules, other transport mechanism, and includes any information delivery media.

The foregoing description of the exemplary embodiments is for illustrative purposes, those with ordinary skill in the art that the technical field pertains to understand that the exemplary embodiments may be expressed in other specific forms without changing the technical idea or essential features of the disclosure that may be modified to be able to understand. Therefore, the exemplary embodiments described above, are exemplary in all respects and it must be understood that the exemplary embodiments are not limiting in any way. For example, each component may be distributed and carried out has been described as a monolithic and describes the components that are to be equally distributed in combined form, may be carried out.

It should be understood that the exemplary embodiments described therein should be considered in a descriptive sense only and not for purposes of limitation. Descriptions of features or aspects within each exemplary embodiment should typically be considered as available for other similar features or aspects in other exemplary embodiments.

While one or more exemplary embodiments have been described with reference to the figures, it will be understood by those of ordinary skill in the art that various changes in form and details may be made therein without departing from the spirit and scope of the present invention as defined by the following claims.

What is claimed is:

1. A color signal processing method comprising:
converting an input signal in a first color space into a luminance component and a saturation component in a second color space;
determining a boundary of the second color space by using the luminance component and the saturation component;
determining whether the converted input signal is outside the boundary; and
matching the saturation component such that the converted input signal outside the boundary of the second color space enters into the boundary of the second color space.

2. The color signal processing method of claim 1, wherein the matching of the saturation component includes adjusting the saturation component without any change in luminance component of the converted input signal.

3. The color signal processing method of claim 1, wherein the determining a boundary includes predicting cusp coordinates on a basis of a hue component of the input signal.

4. The color signal processing method of claim 1, wherein the determining a boundary includes extracting a boundary point having the same luminance component as the converted input signal and the same hue component as the converted input signal.

5. The color signal processing method of claim 1, wherein the determining a boundary includes:
storing anchor color coordinates; and
extracting a boundary point having the same luminance component as the converted input signal and the same hue component as the converted input signal by using the anchor color coordinates.

6. The color signal processing method of claim 5, wherein the anchor color coordinates include cusp coordinates of R, G, B, C, M, and Y.

7. The color signal processing method of claim 4, wherein the matching of the saturation component includes matching the saturation component of the converted input signal with a saturation component of the boundary point.

8. The color signal processing method of claim 5, wherein the matching of the saturation component includes matching the saturation component of the converted input signal with a saturation component of the boundary point that is extracted by using the anchor color coordinates.

9. The color signal processing method of claim 1, further comprising inversely converting the converted input signal into the first color space.

10. The color signal processing method of claim 1, wherein the second color space is a device-dependent color space.

11. The color signal processing method of claim 10, wherein the device-dependent color space is one of RGB, YCbCr, HSI, HSV and HSL color spaces.

12. The color signal processing method of claim 1, further comprising performing a color space conversion on an RGB image to separate the input signal into the luminance component and the saturation component in response to the input signal being an RGB image.

13. A color signal processing apparatus comprising:
a color space converter configured to convert an input signal in a first color space into a luminance component and a saturation component in a second color space;
a color space boundary determiner configured to determine a boundary of the second color space by using the luminance component and the saturation component, and determine whether the converted input signal is outside the boundary; and
a saturation matcher configured to match the saturation component so that the converted input signal outside the boundary of the second color space enters into the boundary of the second color space.

14. The color signal processing apparatus of claim 13, wherein the saturation matcher is configured to match the saturation component without any change in the luminance component of the converted input signal.

15. The color signal processing apparatus of claim 13, wherein the color space boundary determiner is configured to predict cusp coordinates on a basis of a hue component of the input signal.

16. The color signal processing apparatus of claim 13, wherein the color space boundary determiner is configured to extract a boundary point having the same luminance component as the converted input signal and the same hue component as the converted input signal.

17. The color signal processing apparatus of claim 13, wherein the color space boundary determiner includes:
a memory configured to store anchor color coordinates; and
a boundary point extractor configured to extract a boundary point having the same luminance component as the converted input signal and the same hue component as the converted input signal by using the anchor color coordinates.

18. The color signal processing apparatus of claim 17, wherein the anchor color coordinates include cusp coordinates of R, G, B, C, M, and Y.

19. The color signal processing apparatus of claim 16, wherein the saturation matcher is configured to match the saturation component of the converted input signal with a saturation component of the boundary point.

20. The color signal processing apparatus of claim 17, wherein the saturation matcher is configured to match the saturation component of the converted input signal with a saturation component of the boundary point that is extracted by using the anchor color coordinates.

21. The color signal processing apparatus of claim 13, further comprising an inverse converter configured to inversely convert the converted input signal into the first color space.

22. The color signal processing apparatus of claim 13, wherein the second color space is a device-dependent color space.

23. The color signal processing apparatus of claim 22, wherein the device-dependent color space is one of RGB, YCbCr, HSI, HSV and HSL color spaces.

24. The color signal processing apparatus of claim 13, wherein the color signal processing apparatus is configured to perform a color space conversion on an RGB image to separate the input signal into the luminance component and the saturation component in response to the input signal being the RGB image.

25. A non-transitory computer-readable storage medium storing a program, wherein the program, when executed by a processor of a computer, causes the computer to execute the method of claim 1.
